(19) United States
(12) Patent Application Publication
(10) Pub. No.: US 2017/0103443 A1
(43) Pub. Date: Apr. 13, 2017

(54) METHOD TO ENABLE CONSUMER 3D SCANNING SERVICES BY A DISTRIBUTED NETWORK OF SCANNING AGENTS

(71) Applicants: Victor Erukhimov, Moscow (RU); Andrey Filev, San Jose, CA (US)

(72) Inventors: Victor Erukhimov, Moscow (RU); Andrey Filev, San Jose, CA (US)

(21) Appl. No.: 15/288,320

(22) Filed: Oct. 7, 2016

Related U.S. Application Data
(60) Provisional application No. 62/238,642, filed on Oct. 7, 2015.

(51) Int. Cl. G06Q 30/06; H04N 1/34; H04N 1/00; G06F 17/30; G06Q 20/10

(52) U.S. Cl. CPC G06Q 30/0633; G06F 17/30867; G06Q 20/102; H04N 1/00827; H04N 1/344; H04N 2201/0039; H04N 2201/001

(57) ABSTRACT

The present invention provides a method for connecting people with 3D scanners to people who need a 3D scan.

### CROSS REFERENCE TO RELATED APPLICATIONS

This application claims the benefit of U.S. Provisional Application No. 62/238,642, filed Oct. 7, 2015, the entire content of which is incorporated by reference.

### BACKGROUND OF THE INVENTION

### Field of Invention

The present invention relates to a method for connecting people with 3D scanners to people who need a 3D scan.

3D scanning is becoming inexpensive enough to be used by small businesses and prosumers. A 3D model enables a lot of use cases for a consumer, including customization of a game character, various forms of 3D printing, virtual reality applications and more. However, there are not enough consumer devices capable of creating a high quality 3D model of a person, object or environment. The present invention provides a method for creating a network of people and companies who have a 3D scanning device and can offer scanning services to those who don't possess a 3D scanner.

### SUMMARY OF THE INVENTION

We have created a 3D scanner application, itSeez3D, that creates realistic 3D models of people and objects with inexpensive depth sensors such as Structure Sensor [1] and Intel RealSense [2]. A 3D model enables many use cases for a consumer, including 3D printing a color figurine, customization of a game character, virtual reality applications and more. A way to connect a person who can scan with a person who needs a 3D scan is very valuable to enable these applications for every consumer.

We have created a method for connecting people with 3D scanners to people who need a 3D scan. This method consists of the following components: a database of 3D scanners, a method for a 3D scanner service provider to register in the database, a method for any person to find 3D scanning services that meets his needs, the payment/revenue sharing method.

### Database

The database uses the relation model, consisting of multiple tables that reference each other. The database may contain information about the 3D scanning service provider, his location and his availability. An example of a database consists of a set of tables with the following columns:

TABLE 1
3D scanning service providers

| | |
|---|---|
| 1. | ID: a unique identifier for each 3D scanning service provider, |
| | type: integer |
| 2. | Name: a name of a 3D scanning service provider, type: string |
| 3. | Address: address of a 3D scanning service provider, type: string |
| 4. | Mobile: a flag indicating whether a service can be provided |
| | outside of the specified address, type: boolean |
| 5. | Scanner: type of scanner device, type: string |
| 6. | Login: contact email, type: string |

TABLE 2
Services

| | |
|---|---|
| 1. | ID: a unique identifier for each service type, type: integer |
| 2. | Name: service description, type: string |

TABLE 3
Services to providers

| | |
|---|---|
| 1. | ID: record ID, type: integer |
| 2. | ServiceID: service identifier (table 2, column 1), type: integer |
| 3. | ProviderID: provider identifier (table 1, column 1), type: integer |
| 4. | Price: quote from the provider corresponding to the ProviderID for |
| | providing the service corresponding to the ServiceID, type: currency |
| 5. | Custom: description of specific service options |

Table 4: Credentials (Store Credentials for Each Provider)

TABLE 5
Reviews and ratings

| | |
|---|---|
| 1. | ID: record ID, type: integer |
| 2. | ServiceID: service identifier (table 2, column 1), type: integer |
| 3. | ProviderID: provider of the service (table 1, column1), type: integer |
| 4. | Date: date when service was provided, type: date |
| 5. | Rating: rating that user set for the service, type: integer |
| 6. | Review: user review of the service, type: string |

### Register as a Service Provider

Registering for a service provider is done on a website, by filling the form with all the needed information to create a new entry in the database.

### Searching for a 3D Scanning Service

Search for 3D scanning service providers can be performed by anyone visiting the search page of the scanning network website or via a mobile app. Searching and sorting may be done using the parameters available in the database, such as the following:

1. Geographical location

2. Type of service (onsite or mobile)

3. Price of a service

4. Ratings

### Payment/Revenue Sharing

The payment will be done in advance, before scanning, through the scanning network website or a mobile application. The revenue will be shared between the 3D scanning service provider and the scanning network.

The closest methods we are aware of to the present invention are empower 3D printing services [3] and dating services [4]. The former acts as a proxy service provider, connecting the print request to a specific fulfillment company. The latter enables people to meet. Our method is different from both, as it combines a proxy service with a capability for a service provider and a customer to physically meet and execute a scanning process. Our method has similarities to the car sharing model [5], such as Uber [6] and Lyft [7]. We apply a similar model to a problem of sharing 3D scanning resources.

### REFERENCES

[1] Structure Sensor http://structure.io

[2] Intel RealSense http://www.intel.com/content/www/us/en/architecture-and-technology/realsense-overview.html

[3] http://3dhubs.com

[4] US Patent U.S. Pat. No. 6,665,389 B1

https://patentimages.storage.googleapis.com/pdfs/US6665389.pdf

[5] Boyd Cohen and Jan Kietzmann, Organization & Environment 2014, Vol. 27(3) 279-296

Uber http://uber.com

[7] Lyft http://lyft.com

1. A method for obtaining a 3-dimensional scanning service comprising:
a) accessing through the internet a database of 3-dimensional scanning service providers comprising their identities, locations and availability;
b) searching the database for appropriate 3-dimensional scanning service providers; and
c) ordering the scan from one of the appropriate 3-dimensional scanning service providers comprising payment of the scan before the scan is conducted.

2. A method for providing a 3-dimensional scanning service comprising:
a) providing through the internet a database of 3-dimensional scanning service providers comprising their identities, locations and availability;
b) allowing the database to be searched for appropriate 3-dimensional scanning service providers; and
c) allowing the ordering through the internet of a scan from one of the appropriate 3-dimensional scanning service providers comprising payment of the scan before the scan is conducted.
